(19) United States
(12) Patent Application Publication
(10) Pub. No.: US 2007/0158099 A1
(43) Pub. Date: Jul. 12, 2007

(54) INSULATOR DEVICE AND METHOD

(75) Inventors: William Siemonsma, Lyons, SD (US); Walter Baustian, Luverne, MN (US)

Correspondence Address: SCHWEGMAN, LUNDBERG, WOESSNER & KLUTH, P.A., P.O. BOX 2938, MINNEAPOLIS, MN, 55402, US

(73) Assignee: SIEMONSMA, WILLIAM AND BAUSTAIN, WALTER, LYONS, SD (US)

(21) Appl. No.: 11/425,674

(22) Filed: Jun. 21, 2006

Related U.S. Application Data
(60) Provisional application No. 60/692,629, filed on Jun. 21, 2005.
(60) Provisional application No. 60/736,521, filed on Nov. 14, 2005.

(51) Int. Cl. H01B 17/14

(52) U.S. Cl. 174/158 F

(57) ABSTRACT

An insulator for a post capable of being configured to a plurality of configurations and methods for using the insulator.

### RELATED APPLICATIONS

This application claims the benefit under 35 U.S.C. 119(e) of U.S. Provisional Application Ser. No. 60/692,629 filed Jun. 21, 2005, and U.S. Provisional Application Ser. No. 60/736,521 filed Nov. 14, 2005.

### FIELD OF THE INVENTION

The invention relates to an insulator device and method, and more particularly to the insulator associated with a fence.

### BACKGROUND OF THE INVENTION

Electric fences are commonly used to control animals. An electric fence generally includes a bare current-carrying wire. When an animal standing on the ground touches the bare wire, current from the current-carrying wire passes through the animal to ground. The power level is high enough to cause discomfort to the animal yet low enough so as not to be harmful to the animal. In some applications an electric fence is used to prevent certain animals from entering an area. For example, raccoons love sweet corn. An electric fence strung low to the ground is used to prevent raccoons from entering a patch of sweet corn so that a farmer still has sweet corn to harvest and sell. In other applications, an electric fence is used to prevent other animals from leaving an area. For example, cattle can be kept in a particular field. After harvesting field corn, one farmer may lease his land to another so that the cattle can eat the unharvested corn over the winter. The landowner may not have a fence. The farmer renting the land can place an electric fence around the field to keep the cattle in. In another application, an electric fence is used to keep horses away from a wooden fence. Some high strung breeds of horses chew on wooden fences unless kept away by an electric fence.

Electric fences can be constructed as a new fence or added to an existing fence. In agricultural environments, three types of posts are commonly used for fencing. The three types include wood posts, t-posts, and rods. The t-posts and rods are typically made of metal. Each of the fence posts is placed in the ground and therefore includes a path to ground. As a result, a current-carrying wire held at a potential must be insulated from each type of fence post. Currently, three types of insulators are used to hold a bare current carrying wire in spaced relation with respect to the three different types of fence posts. Depending on the construction of a fence, farmers need to have a different type of insulators for each and every type of fence post used. For example, if the fence includes wooden posts and t-posts, then the farmer must carry two types of insulators for the two types of posts. It is not uncommon to have all three different types of fence posts used on a fence and therefore three types of insulators must be carried by the farmer in order to make the fence.

This is complex for farmer as they have to keep a number of different insulators on hand during construction of a fence or when retrofitting a current fence to include a bare current-carrying wire for an electric fence. In addition, having different insulators for different types of fence posts also poses a problem in a retail store. The retailer must carry all the types in inventory. There are also several different makers of insulators. As a result, a fair amount of shelf space is devoted to one product. With shelf space at a premium in many retail stores, a large amount of shelf space for one product translates into less shelf space available for other products.

### BRIEF DESCRIPTION OF THE DRAWINGS

The following detailed description of the preferred embodiments can best be understood when read in conjunction with the following drawings, in which:

FIG. 1 is a schematic view of a fencing system that uses the insulator and method, according to an example embodiment.

FIG. 2 is a top view of an insulator for a post, according to an example embodiment.

FIG. 3 is a bottom view of an insulator for a post, according to an example embodiment.

FIG. 4A is a bottom view of an insulator for a post having a pair of wire-retaining clips, according to an example embodiment.

FIG. 4B is a side view of an insulator for a post showing the wire-retaining clips, according to an example embodiment.

FIG. 5A is a bottom view of an insulator for a post having a pair of wire-retaining clips, according to an example embodiment.

FIG. 5B is a side view of an insulator for a post showing the wire-retaining clips, according to an example embodiment.

FIG. 6 is a top view of an insulator for a post, according to an example embodiment.

FIG. 7 is a perspective view of an insulator for a post configured to hold an uninsulated wire from a metal rod, according to an example embodiment.

FIG. 8 is a perspective view of an insulator for a post configured to hold an uninsulated wire from a wooden post, according to an example embodiment.

FIG. 9 is a perspective view of an insulator for a post configured to hold an uninsulated wire from a metal t-post, according to an example embodiment.

FIG. 10 is a perspective view of an insulator for a post configured to hold an uninsulated wire from a metal t-post, according to an example embodiment.

FIG. 11 is a perspective view of a plurality of posts each carrying an insulator configured to hold an uninsulated wire, according to an example embodiment.

FIG. 12 is a perspective view of a plurality of posts each carrying an insulator configured to hold an uninsulated wire, according to an example embodiment.

FIG. 13 is a schematic view of a kit including at least one insulator and a set of instructions, according to an example embodiment.

FIG. 14 is a flow diagram of a method, according to an example embodiment.

FIG. 15 is a flow diagram of a method, according to an example embodiment.

FIG. 16 is a side view of an insulator for a post, according to another example embodiment.

FIG. 17 is a side view of an insulator for a post, according to another example embodiment.

FIG. 18A is a bottom view of an insulator for a post having a pair of wire-retaining clips, according to an example embodiment.

FIG. 18B is a side view of an insulator for a post showing the wire-retaining clips, according to an example embodiment.

FIG. 19A is a bottom view of an insulator for a post having a pair of wire-retaining clips, according to an example embodiment.

FIG. 19B is a side view of an insulator for a post showing the wire-retaining clips, according to an example embodiment.

### DETAILED DESCRIPTION

In the following detailed description, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

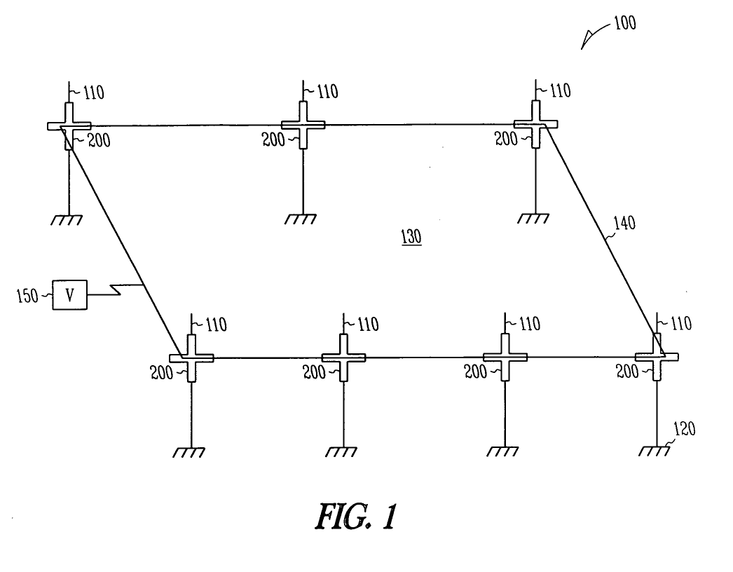

FIG. 1 shows a schematic view a fencing system 100 that uses the insulator 200 and method, according to an example embodiment.

The fencing system 100 includes the plurality of fenceposts 110, placed within the ground 120. The fenceposts 110 are positioned around an area 130. The fenceposts 110 can be any type of fenceposts, including a wooden fencepost, a metal rod, or a metal t-bar type fencepost, or the like. An insulator 200 is carried or attached to each of the fenceposts 110. Attached to the insulators 200 is a bare wire 140. Also attached to the bare wire 140 is a power or voltage source 150. The power or voltage source 150 is used to maintain the wire 140 at a selected potential. When an animal or other thing contacts the wire 140, current flows through the wire and through the animal to the ground 120, on which the animal is standing. The voltage or power level is selected so as not to harm an animal or human, but merely to produce an uncomfortable shock. The insulators 200 on the fenceposts 110 prevent the wire 140 from shorting to ground 120 through a fencepost 110. The insulators 200 fit on a variety of types of fenceposts. The fenceposts 110 are shown schematically but can include any type of fencepost, including a wooden fencepost, a t-bar fencepost, a metal rod, or the like.

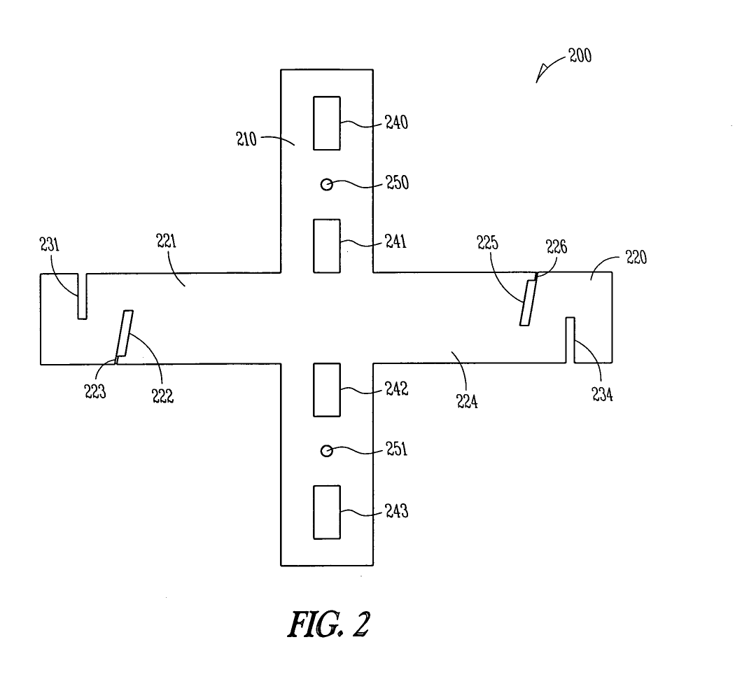

FIG. 2 is a top view of an insulator 200 for a post, according to an example embodiment. The insulator includes a main body 210, and a cross member 220. The cross member 220 includes a first tab 221 having a first opening 222 therein, and a second tab 224 having a second opening 225 therein. In one embodiment, the first opening 222 and the second opening 225 are adapted to receive a wire. In another embodiment, the first opening 221 and the second opening 225 are adapted to retain a wire. In some embodiments, the first tab 221 includes a slit 223 between the first opening 222 and an edge of the first tab 221, and the second tab 225 includes a slit 226 between the second opening 225 and an edge of the second tab 224. In another embodiment, the first tab 221 includes a slit 223 between the first opening 222 and an edge of the insulator 200, and the second tab 224 includes a slit 226 between the second opening 225 and an edge of the insulator 200. The main body 210 of the insulator 200 includes at least one opening 240 for orienting the insulator with respect to a pole 110. As shown in FIG. 2, the main body 210 includes four openings 240, 241, 242, and 243 for orienting the insulator with respect to a certain type of pole 110, namely a t-post fence post. The main body 210 also includes at least one opening 250 adapted for attachment of the insulator 200 to a pole 110 is further adapted to receive a fastener for attachment of the insulator 200 to a pole 110. As shown in FIG. 2, the main body 210 includes two openings 250, and 251 sized to receive a fastener, such as a nail or screw. It should be noted that the number of openings for orienting the insulator with respect to a certain type of pole 110, and the number of openings for attaching the insulator 200 to the pole 110, are not fixed and can be varied. The first tab 221 also has a first groove 231 therein, and the second tab 224 also has a second groove 234 therein. The first tab 221 and the second tab 224 are sized to engage one another. In some orientations of the insulator 200, the groove 231 of the first tab 221, and the groove 234 of the second tab 224 are used to attach the insulator to a pole 110.

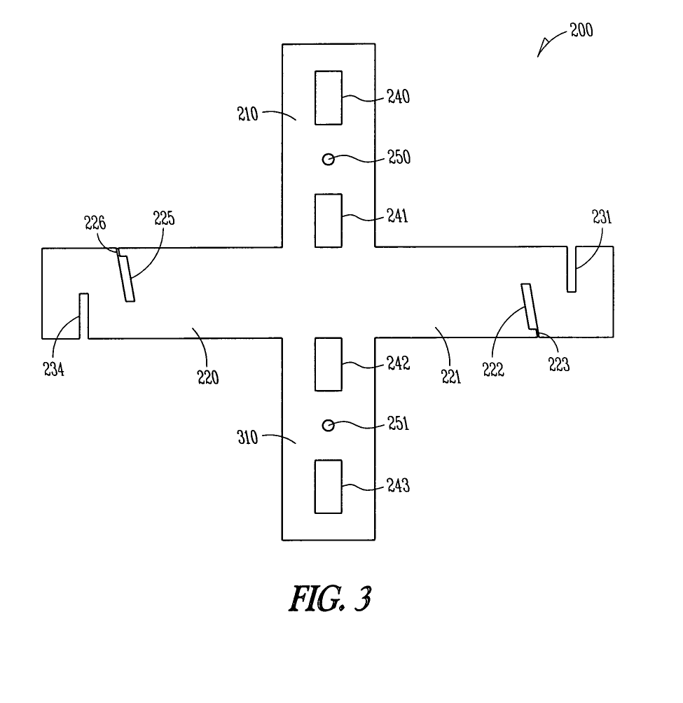

FIG. 3 is a bottom view of an insulator 200 for a post 110, according to an example embodiment. The insulator 200 includes a bottom surface 310. The bottom surface 310 as shown in FIG. 3 is substantially flat and devoid of features. The bottom surface 310 has the same features as the view from the top of the insulator 200 as shown in FIG. 2.

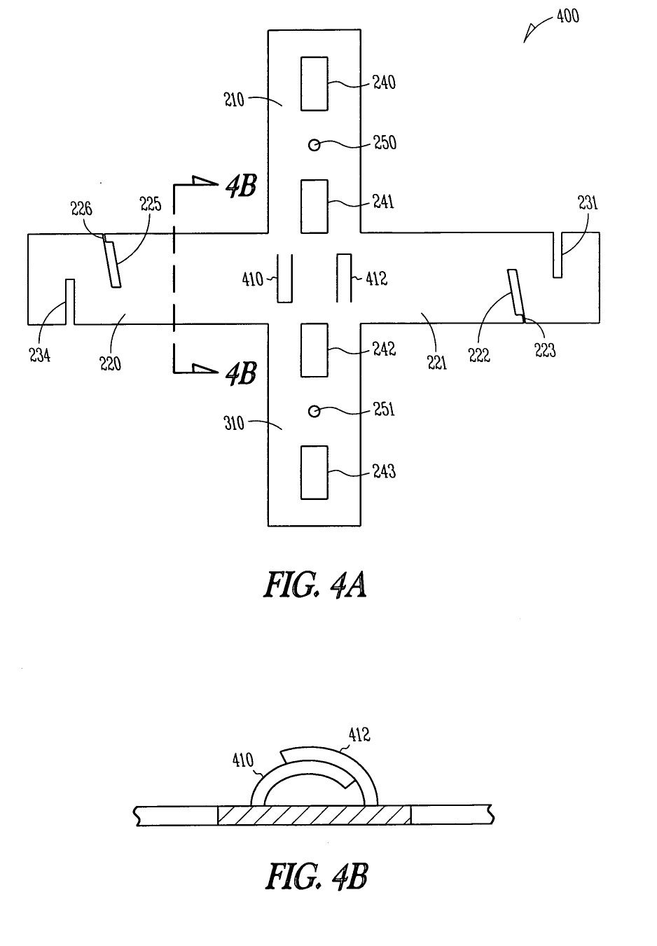

FIGS. 4A and 4B are views of an insulator 400 for a post 110, according to an example embodiment. FIG. 4A is a bottom view of the insulator 400 for a post having a first wire-retaining clip 410 and a second wire-retaining clip 412, according to an example embodiment. FIG. 4B is a cut-away side view of an insulator 400 for a post 110 along line 4B-4B of FIG. 4A, according to an example embodiment. Referring now to both FIGS. 4A and 4B, the insulator 400 will be further discussed. The insulator 400 includes the first wire-retaining clip 410 and a second wire-retaining clip 412 on the bottom surface 310 of the main body 210 of the insulator 400. The first wire-retaining clip 410 and a second wire-retaining clip 412 are curved and offset from one another. The free end of the first wire-retaining clip 410 extends past the free end of the second wire-retaining clip 412. A wire, such as wire 140, can then be held by the first wire-retaining clip 410 and a second wire-retaining clip 412. The offset between the first wire-retaining clip 410 and a second wire-retaining clip 412 allows the wire, such as wire 140, to be held away from the post 110, such as a t-post, on the side of the t-post which includes multiple protrusions.

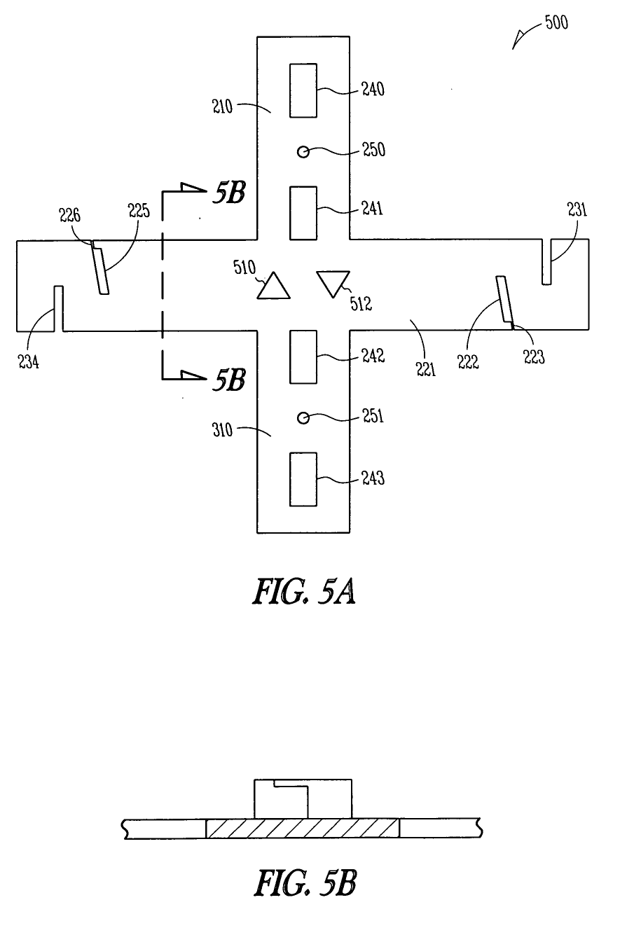

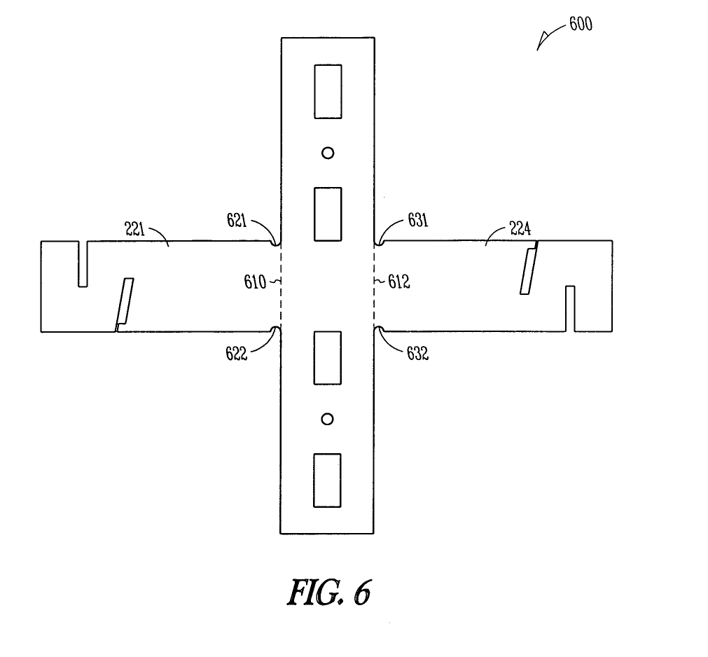

FIGS. 5A and 5B are views of an insulator 500 for a post 110, according to an example embodiment. FIG. 5A is a bottom view of the insulator 500 for a post having a first wire-retaining clip 510 and a second wire-retaining clip 512, according to an example embodiment. FIG. 5B is a cut-away side view of an insulator 500 for a post 110 along line 5B-4B of FIG. 5A, according to an example embodiment. Referring now to both FIGS. 5A and 5B, the insulator 500 will be further discussed. The insulator 500 includes the first wire-retaining clip 510 and a second wire-retaining clip 512 on the bottom surface 310 of the main body 210 of the insulator 500.

FIG. 6 is a top view of an insulator 600 for a post, such as post 110, according to an example embodiment. The insulator 600 includes many of substantially the same features as the insulator 200 shown in FIGS. 2 and 3. The differences between the insulator 600 and the insulator 200 will be discussed here for the sake of brevity. The insulator 600 includes a first hinge 610 and a second hinge 612. The first hinge 610 is located between the first tab 221 and the main body 210 of the insulator 600. The second hinge 612 is located between the second tab 224 and the main body 210 of the insulator 600. In some embodiments, the first hinge 610 and the second hinge 612 are living hinges. Living hinges are substantially thinner linear regions of plastic. When the first tab 221 is folded with respect to the main body 210, the fold will tend to follow the first living hinge 610. Similarly, when the second tab 224 is folded with respect to the main body 210, the fold will tend to follow the second living hinge 612. The insulator 600 also includes a notch 621, and a notch 622 which occur at the ends of the first hinge 610. The insulator 600 also includes a notch 631, and a notch 632 which occur at the ends of the second hinge 612. The notches 621, 622, 631, 632 are u-shaped. In another embodiment, the notches are v-shaped. It is contemplated that the notches could be shaped in any number of ways and still be within the scope of the invention.

Each of the insulators 200, 400, 500 could be made by molding plastic within a mold. A mold for forming the insulator set forth above. The insulator 200 can be formed by either molding or by stamping. This application also contemplates a mold for forming the insulators 200, 400, 500 as illustrated and described in the above portions of the description.

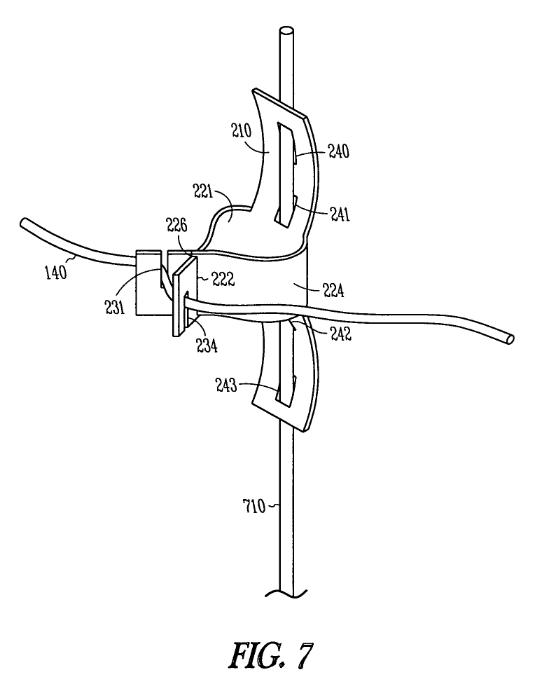

FIG. 7 is a perspective view of an insulator 200 for a post configured to hold an uninsulated wire 140 from a metal rod 710, according to an example embodiment. The insulator 200 is shown in the first configuration which is used to hold an uninsulated wire 140 from the metal rod 710. The metal rod 710 is passed through the openings 243, 242, 241, 240 in the main body 210 of the insulator 200. The main body 210 is made of a plastic material and has a thickness that provides a spring force that holds the insulator 200 onto the metal rod 710 in a substantially fixed position. The first tab 221 and the second tab 224 of the cross member 220 are folded with respect to the main body 210 of the insulator 200. The first tab 221 and the second tab 224 are attached to one another by interlocking opening 222 of the first tab 221 with the opening 225 of the second tab 224 with one another. The wire 140 is then passed through groove 231 in the first tab 221 and groove 234 of the second tab 224. The wire 140 is then held at a substantially enough distance away from the metal rod 710 so that electricity will not conduct between the bare wire 140 and the metal rod 710.

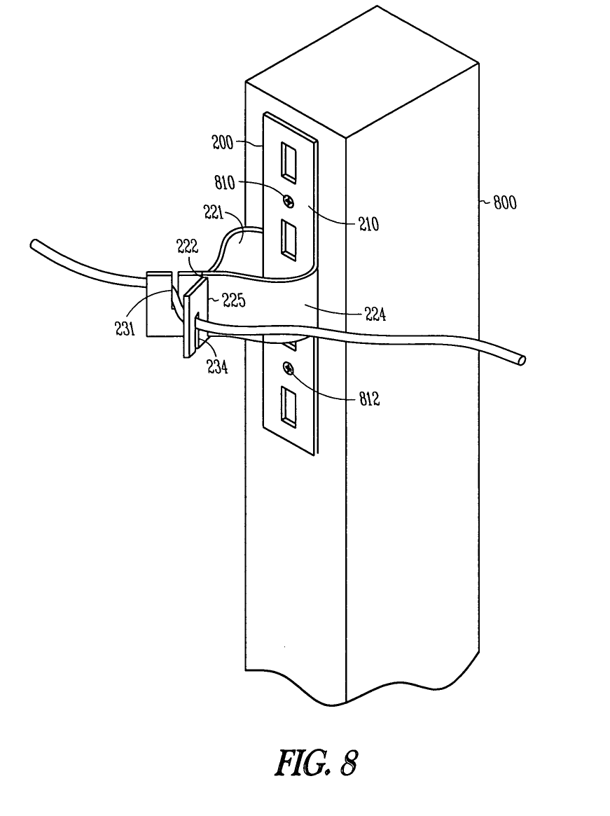

FIG. 8 is a perspective view of an insulator 200 configured to hold an uninsulated wire 140 from a wooden post 800. The insulator 200 is attached to the wooden post 800 via a first fastener 810 and a second fastener 812. The first fastener 810 passes through the attachment opening 250 (shown in FIGS. 2 and 3) and the second fastener 812 passes through the attachment opening 251 (shown in FIGS. 2 and 3). The first tab 221 and the second tab 224 are then folded with respect to the main body 210 of the insulator 200. The first tab 221 is interconnected with the second tab 224 via the openings 222 by interlocking the openings 222 in the first tab 221 with the opening 225 in the second tab 224. The bare wire 140 is then passed through groove 231 in the first tab 221 and through groove 234 in the second tab 224. The wire 140 is then held away from the post 800 so as to prevent the conducting of electricity between the bare wire 140 and the post 800.

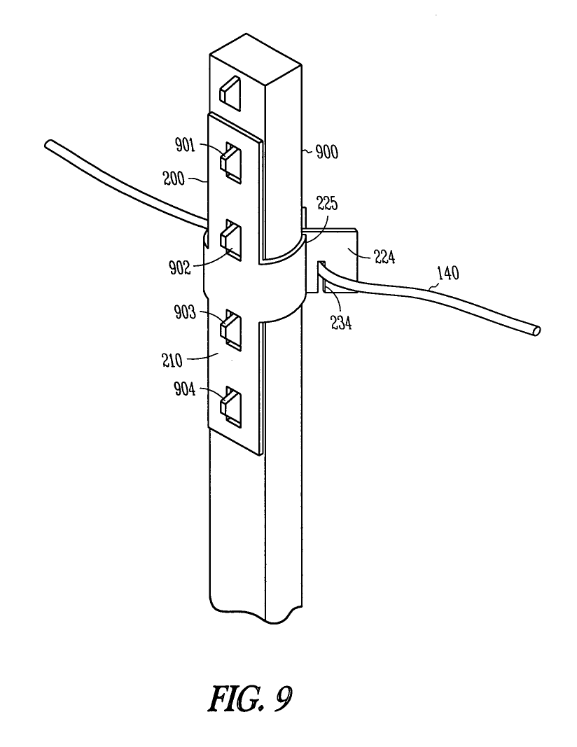

FIG. 9 is a perspective view of an insulator 200 for a post configured to hold an uninsulated wire 140 from a metal t-post 900. The metal t-post 900 includes a number of protrusions, such as protrusion 901, protrusion 902, protrusion 903, and protrusion 904. The openings 240, 241, 242, 243 in the main body 210 of the insulator 200 are placed over the protrusions 901, 902, 903, 904 of the metal t-post 900. In other words, the openings 240, 241, 242, 243 are positioned so that they register with the protrusions 901, 902, 903, 904 of the metal t-post 900. The protrusions interacting with the openings prevent up and down motion of the insulator 200 with respect to the metal t-post 900. The first tab 221 and the second tab 224 of the cross member 220 are folded with respect to the main body 210 of the insulator 200. The first tab 221 and the second tab 224 are wrapped around the metal t-post 900 and then the opening 222 in the first tab 221 is engaged with the opening 225 in the second tab 224 to hold the insulator or secure the insulator 200 with respect to the metal post 900. The bare wire 140 is then passed through the groove 231 in the first tab 221 and through the groove 234 in the second tab 224. Thus, as shown in FIG. 9, the insulator 200 is in a third orientation with respect to the metal t-post 900.

FIG. 10 is a perspective view of an insulator 300 for a post configured to hold an uninsulated wire 140 away from the metal t-post 900, according to an example embodiment. The openings 240, 241, 242, 243 in the main body 210 of the insulator 200 are registered with protrusions 901, 902, 903, 904 on the metal t-post 900. The first tab 221 is folded with respect to the main body, and the second tab 224 is folded with respect to the main body of the insulator 400. The first tab 221 and the second tab 224 wrap around the metal t-post 900 and are interlocked with one another via the opening 222 in the first tab 221 and by the opening 225 in the second tab 224. The bare wire is then passed through first wire retaining clip 410 and the second wire retaining clip 412 on the bottom surface 310 of the insulator 400. The first wire retaining clip 410 and the second wire retaining clip 412 hold the wire in an insulated position with respect to the t-post 900. The first wire retaining clip 410 and the second wire retaining clip 412 are offset from one another so that the wire 140 can be inserted merely by slightly twisting the wire to make it go under the first wire retaining clip 410 and under the second wire retaining clip 412.

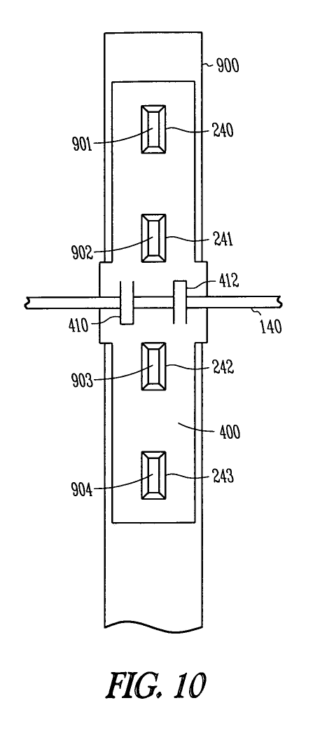

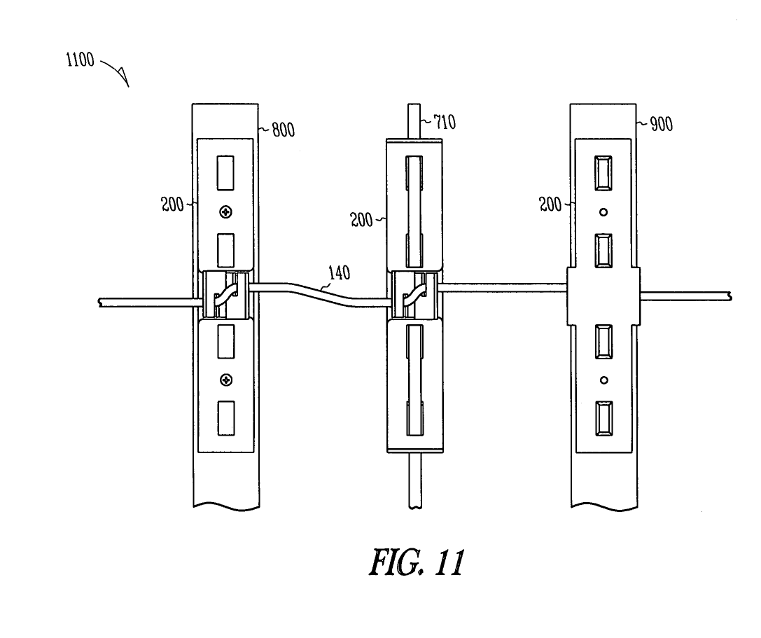

FIG. 11 is a perspective view of a plurality of posts, such as post 800, 710, 900, each carrying an insulator 200 configured to hold an uninsulated or bare wire away from its respective post, according to an example embodiment. This is an example of a fencing system 1100 that includes at least three types of posts, 800, 710, 900, having an insulator 200 used in three configurations to attach to the various different types of posts 800, 710, 900. The methods for attaching the insulators 200 to the various types of posts 800, 710, 900, have been discussed with respect to FIG. 7, FIG. 8 and FIG. 9. Therefore, the methods for attaching the insulator 200 to the post, as well as attaching the uninsulated wire to the insulator will not be further detailed here. However, generally the insulators 200 are attached to the various types of posts used in a fencing system 1100. The insulators 200 are generally positioned so that they are at approximately the same height above the ground when on their respective posts. Once the insulators 200 are attached to the posts 800, 710, 900, the wire 140 is then attached to the insulators 200. For example, the wire 140 is attached to the insulator 200, attached to the wooden post 800 and then to the insulator 200 attached to the metal rod 710 and then attached to the insulator 200 attached to the t-post 900. It is also contemplated that this fencing system may be used to illustrate or instruct how the insulator 200 can be configured in a plurality of ways to hold an uninsulated wire 140 away from the various different types of posts, such as the wooden post 800, the metal rod 710, and the metal t-post 900. Such a fencing system 1100 could be used as a non-verbal set of instructions. In addition, it is contemplated that the three types of posts, or a portion of the three types of posts, could be used as a display in a store to instruct customers as to how to use the insulator 200.

A display for a store includes at least a portion of a first type of post 800 including an insulator 200 configured in a first configuration, and at least a portion of a second type of post 710 including an insulator 200 configured in a second configuration. The first insulator 200 and the second insulator 200 are substantially the same. A wire 140 held by the first insulator 200 and the second insulator 200 in an example embodiment of the display of the fencing system 1100 for a store or other retail environment. In other embodiments, the display also includes at least a portion of a third type of post 900. On the third type of post 900, the insulator 200 is configured in a third configuration. The first insulator 200, the second insulator 200, and the third insulator 200 are substantially the same. The wire 140 is held by the first insulator 200, the second insulator 200, and the third insulator 200.

FIG. 12 is a perspective view of a plurality of posts 710, 800, 900, 900′ each carrying an insulator 400 configured to hold an uninsulated wire 140, according to an example embodiment. FIG. 12 illustrates a fencing system 1200 which uses an insulator 400 configured in three different ways to hold the uninsulated wire 140 away from three types of posts. The fencing system 1200 could also be used as a display in a retail setting or as a set of non verbal instructions. The display, instruction set or fencing system includes a wire 140 held by the first insulator 400, the second insulator 400, and the third insulator 400, and the fourth insulator 400. In the display, the types of posts include a metal post, such as a rod 710, or a t-post 900, and a wooden post 800.

A system includes a first post and a second post, an insulator associated with the first post, an insulator associated with the second post, and a wire retained by the insulator associated with the first post and retained by the insulator on the second post. The insulator associated with the first post and the insulator associated with the second post are substantially the same. However, the insulator associated with the first post and the insulators associated with the second post are configured differently. In some embodiments of the system, there is a third insulator configured to be associated with a third post. In still another embodiment of the system, a fourth insulator is associated with one of the first, second or third post. The fourth insulator is adapted to retain a wire in a different way than the first insulator, the second insulator or the third insulator.

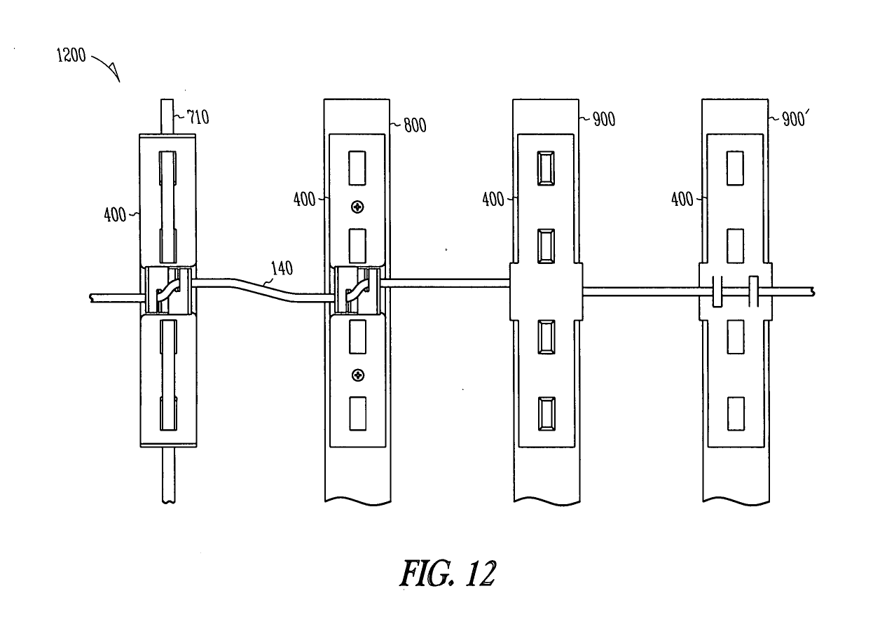

FIG. 13 is a schematic view of a kit 1300 including at least one insulator 200, 400, 500 and a set of instructions 1310, according to an example embodiment.

The kit 1300 includes an insulator 200, 400, 500 for a post, and a set of instructions 1310. The insulator 200, 400, 500 is configurable to a plurality of configurations. The instructions 1310, in one embodiment, are packaged with the insulators. The instructions include at least a first description of configuring the insulator in a first configuration for a first type of post, and a second description of configuring the insulator in a second configuration for a second type of post. In some embodiments, the instructions further include a third description of configuring the insulator in a third configuration for a third type of post. In another embodiment of the instructions, a fourth description for configuring the insulator to a fourth configuration is included. In some embodiments, the fourth configuration is for one of the first post, the second post or the third post. A wire may be shown in each of the embodiments. The instructions for the various configurations may be a visual description that includes drawings or pictures of the insulator in various configurations or may be a written description or a combination of both. The insulator or a plurality of insulators may be packaged in a container 1320 along with at least a portion of the set of instructions.

FIG. 14 is a flow diagram of a method 1400, according to an example embodiment. The method 1400 includes orienting a first insulator in a first configuration with respect to a first type of post 1410, and orienting a second insulator in a second configuration with respect to a second type of post 1412. In the method 1400, the first insulator and the second insulator are substantially the same. In some embodiments, the method 1400 also includes orienting a third insulator in a third configuration with respect to a third type of post 1414. The third insulator is substantially the same as the first insulator and the second insulator. In still another example embodiment, the method 1400 also includes orienting a fourth insulator in a fourth configuration with respect to a third type of post 1416. The method 1400 further includes attaching a wire to at least two of the first insulator and the second insulator 1418.

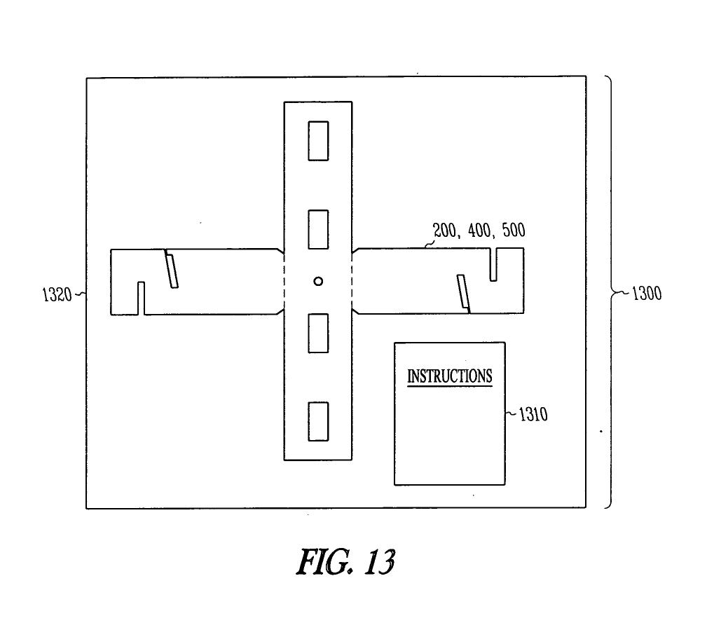

FIG. 15 is a flow diagram of a method 1500, according to an example embodiment. The method 1500 includes determining a type of post to which an insulator will be attached 1510, and orientating the insulator to one of a plurality of configurations 1512. Orientating the insulator to one of a plurality of configurations 1512 includes configurations for electrically insulating a bare wire from the post and attaching the insulator to the post 1514.

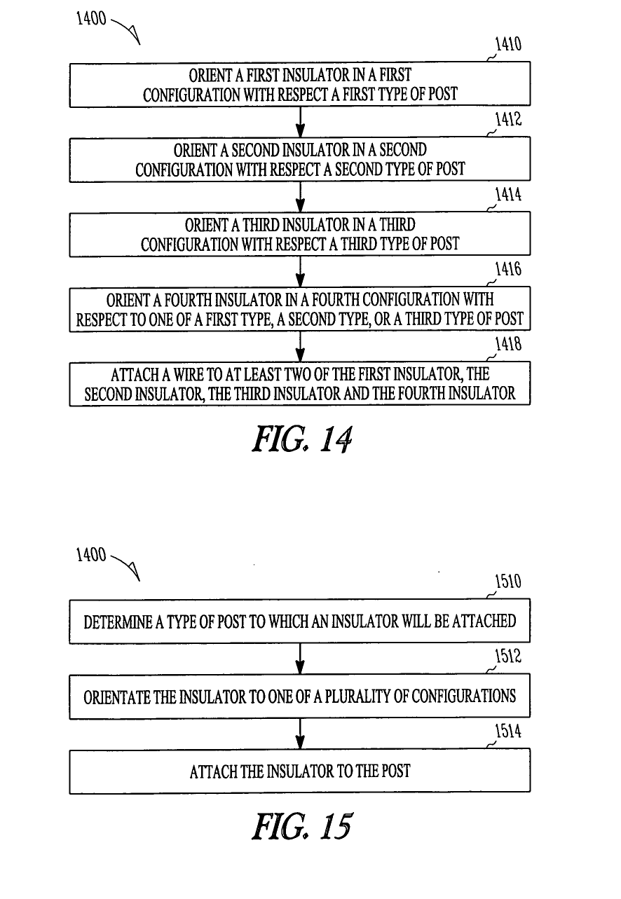

FIG. 16 is a side view of an insulator 1600 for a post configured to hold an uninsulated wire 140 away from the metal t-post 900, according to an example embodiment. The insulator includes a first and second cross member that when folded around the post 900 resemble a tractor 1610 that includes a body 1612 and a first wheel 1614 and a second wheel 1616 attached to the body 1612. The insulator 1600 can include material of different colors. For example, the wheels 1614, 1616 can be made of a black material and the body 1612 of the tractor 1610 can be made of a yellow material. The top of the post 900 then resembles a cab of a tractor 1610. Different colors can also be applied to the surface of the material forming the insulator 1600. In one embodiment, the material forming the insulator 1600 can be reflective so that the insulator 1600 is viewable during low light conditions. In one embodiment, the insulator includes the various slots needed to attach one cross member to the other cross member as well as to hold an uninsulated wire a distance from the post 900. In another embodiment, the slots for holding the uninsulated wire are eliminated making the insulator 1600 a decorative device for a fence post, such as fence post 900.

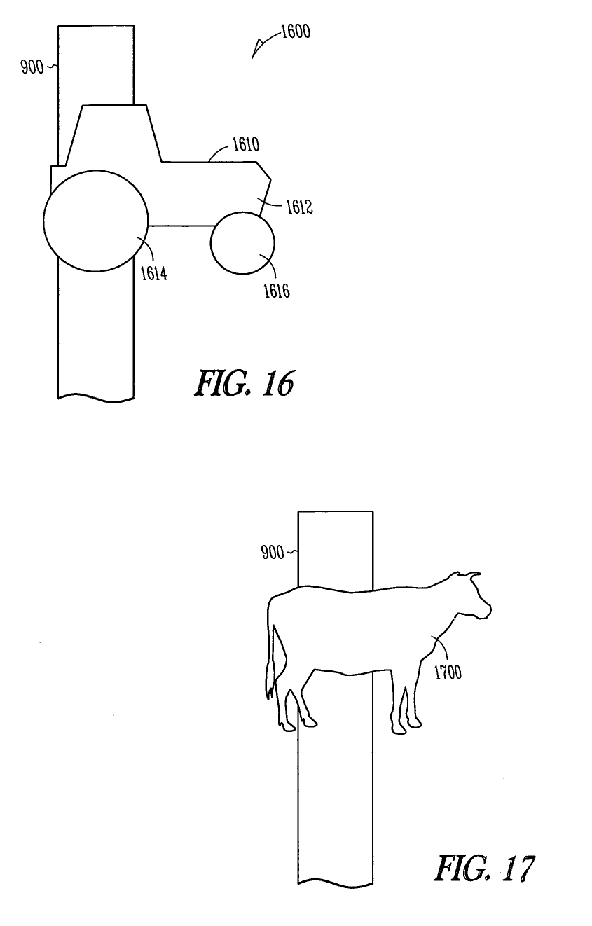

FIG. 17 is a side view of an insulator 1700 for a post 900, according to another example embodiment. A fence post insulator can be shaped in any number of shapes such as animals, people, articles of manufacture or even labels that advertise a brand for a product or the like. FIG. 17 shows just one example where the insulator 1700 includes cross members which, when connected to one another, form the shape of a cow. In one embodiment, the insulator includes the various slots needed to attach one cross member to the other cross member as well as to hold an uninsulated wire a distance from the post 900. In another embodiment, the slots for holding the uninsulated wire are eliminated making the insulator 1700 a decorative device for a fence post, such as fence post 900. Different colors can also be applied to the surface of the material forming the insulator 1700. In another embodiment, different colored materials are molded together to form the insulator 1700. In one embodiment, the material forming the insulator 1700 can be reflective so that the insulator 1700 is viewable during low light conditions.

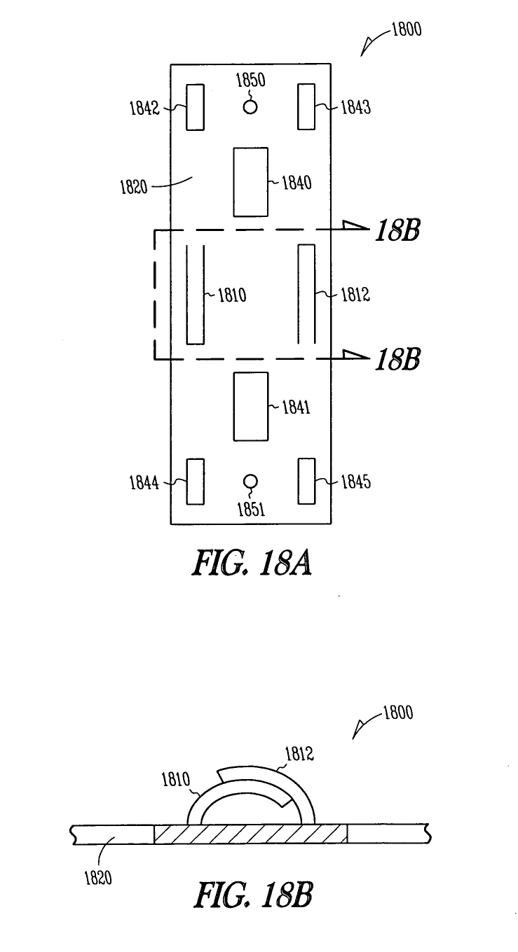

FIGS. 18A and 18B are views of an insulator 1800 for a post 110, according to another example embodiment. FIG. 18A is a bottom view of the insulator 1800 for a post having a first wire-retaining clip 1810 and a second wire-retaining clip 1812, according to an example embodiment. FIG. 18B is a cut-away side view of an insulator 1800 for a post 110 (shown in previous FIGs.) along line 18B-18B of FIG. 18A, according to an example embodiment. Referring now to both FIGS. 18A and 18B, the insulator 1800 will be further discussed. The insulator 1800 includes a main body 1820. The main body 1820 of the insulator 1800 includes at least one opening 1840 for orienting the insulator with respect to a pole 110. As shown in FIG. 18A, the main body 1820 includes two openings 1840 and 1841 for orienting the insulator with respect to a certain type of pole 110, namely a t-post fence post. The main body 1820 also includes a pair of openings 1842 and 1843, and a pair of openings 1844 and 1845 for holding an elongated fastener, such as a plastic tie, plastic cable tie or a length of wire. The elongated fastener can be threaded through each pair of openings. The main body 1820 also includes at least one opening 1850 adapted for attachment of the insulator 1800 to a pole 110 is further adapted to receive another type of fastener for attachment of the insulator 1800 to a pole 110. As shown in FIG. 18A, the main body 1820 includes two openings 1850 and 1851 sized to receive a fastener, such as a nail or screw. It should be noted that the number of openings for orienting the insulator with respect to a certain type of pole 110, and the number of openings for attaching the insulator 1800 to the pole 110, are not fixed and can be varied.

The insulator 1800 includes the first wire-retaining clip 1810 and a second wire-retaining clip 1812 on the main body 1820 of the insulator 1800. The first wire-retaining clip 1810 and a second wire-retaining clip 1812 are curved and offset from one another. The free end of the first wire-retaining clip 1810 extends past the free end of the second wire-retaining clip 1812. A wire can then be held by the first wire-retaining clip 1810 and a second wire-retaining clip 1812. The offset between the first wire-retaining clip 1810 and a second wire-retaining clip 1812 allows the wire, such as wire 140 shown in previous FIGs., to be held away from the post 110.

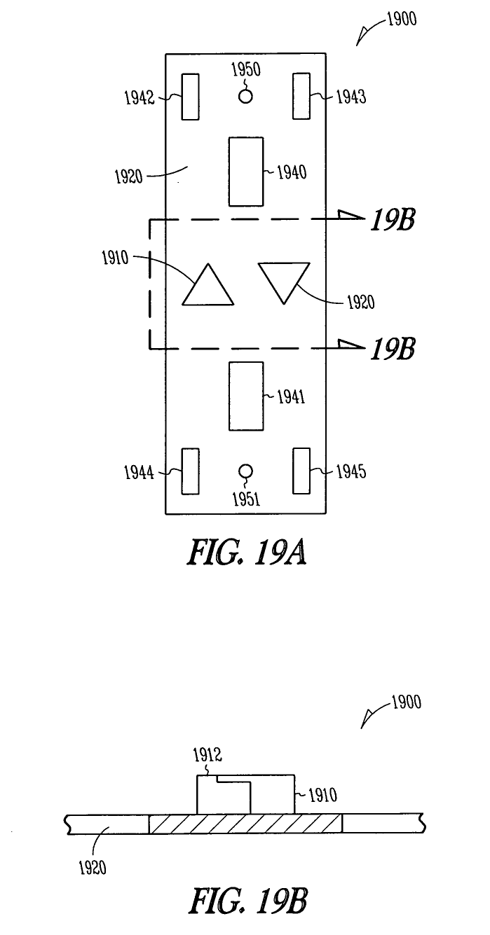

FIGS. 19A and 19B are views of an insulator 1900 for a post 110, according to another example embodiment. FIG. 19A is a bottom view of the insulator 1900 for a post having a first wire-retaining clip 1910 and a second wire-retaining clip 1912, according to an example embodiment. FIG. 19B is a cut-away side view of an insulator 1900 for a post 110 (shown in previous FIGs.) along line 19B-19B of FIG. 19A, according to an example embodiment. Referring now to both FIGS. 19A and 19B, the insulator 1900 will be further discussed. The insulator 1900 includes a main body 1920. The main body 1920 of the insulator 1900 includes at least one opening 1940 for orienting the insulator with respect to a pole 110. As shown in FIG. 19A, the main body 1920 includes two openings 1940 and 1941 for orienting the insulator with respect to a certain type of pole 110, namely a t-post fence post. The main body 1920 also includes a pair of openings 1942 and 1943, and a pair of openings 1944 and 1945 for holding an elongated fastener, such as a plastic tie, plastic cable tie or a length of wire. The elongated fastener can be threaded through each pair of openings. The main body 1920 also includes at least one opening 1950 adapted for attachment of the insulator 1900 to a pole 110 is further adapted to receive another type of fastener for attachment of the insulator 1900 to a pole 110. As shown in FIG. 19A, the main body 1920 includes two openings 1950 and 1951 sized to receive a fastener, such as a nail or screw. It should be noted that the number of openings for orienting the insulator with respect to a certain type of pole 110, and the number of openings for attaching the insulator 1900 to the pole 110, are not fixed and can be varied.

The insulator 1900 includes the first wire-retaining clip 1910 and a second wire-retaining clip 1912 on the main body 1920 of the insulator 1900. The first wire-retaining clip 1910 and a second wire-retaining clip 1912 are triangularly-shaped and offset from one another. The free end of the first wire-retaining clip 1910 extends past the free end of the second wire-retaining clip 1912. A wire can then be held by the first wire-retaining clip 1910 and a second wire-retaining clip 1912. The offset between the first wire-retaining clip 1910 and a second wire-retaining clip 1912 allows the wire, such as wire 140 shown in previous FIGs., to be held away from the post 110.

The insulators 1800 or 1900 can be provided with a set of fasteners in kit form. A kit could include a set of elongated fasteners, such as the plastic cable ties, which are threaded through the pairs of openings 1842 and 1843, and 1844 and 1845 for insulator 1800. A kit could also include a set of elongated fasteners, such as the plastic cable ties, which are threaded through the pairs of openings 1942 and 1943, and 1944 and 1945 for insulator 1900.

Thus, a system, method, and an individual insulator capable of a plurality of orientations, and a kit including instructions and a plurality of insulators have been described. Although the present invention has been described with reference to specific example embodiments, it will be evident that various modifications and changes may be made to these embodiments without departing from the broader spirit and scope of the disclosed subject matter. Accordingly, the specification and drawings are to be regarded in an illustrative rather than a restrictive sense.

What we claim is:

1. An insulator comprising:
a main body; and
a cross member including:
a first tab having a first opening therein; and
a second tab having a second opening therein.

2. The insulator of claim 1 wherein the first opening and the second opening are adapted to receive a wire.

3. The insulator of claim 1 wherein the first opening and the second opening are adapted to retain a wire.

4. The insulator of claim 1 wherein the first tab includes a slit between the first opening and an edge of the first tab, and wherein the second tab includes a slit between the second opening and an edge of the second tab.

5. The insulator of claim 1 wherein the first tab includes a slit between the first opening and an edge of the insulator, and wherein the second tab includes a slit between the second opening and an edge of the insulator.

6. The insulator of claim 1 wherein the main body includes at least one opening for orienting the insulator with respect to a pole.

7. The insulator of claim 1 wherein the main body includes at least one opening adapted for attachment of the insulator to a pole.

8. The insulator of claim 1 wherein the main body includes at least one opening adapted to receive a fastener for attachment of the insulator to a pole.

9. The insulator of claim 1 wherein the first tab has a first groove therein, and wherein the second tab has a second groove therein.

10. The insulator of claim 1 wherein the first tab has a first groove therein, and wherein the second tab has a second groove therein, the first tab and the second tab sized to engage one another.

11. The insulator of claim 1 adapted to hold a portion of fencing material away from a post, the insulator configurable to attach to a plurality of post types.

12. The insulator of claim 1 wherein the tabs are shaped to form an outline of an object.

13. The insulator of claim 1 wherein the tabs include advertising material.

14. A kit comprising:
an insulator for a post, the insulator configurable to a plurality of configurations adapted for attachment to a plurality of post types; and
a set of instructions.

15. The kit of claim 14 further comprising a container.

16. The kit of claim 14 further comprising a container, wherein at least a portion of the set of instructions is placed on the container.

17. The instruction set of claim 14 wherein the set of instructions is formed on the insulator.

18. A method comprising:
orienting a first insulator in a first configuration with respect to a first type of post; and
orienting a second insulator in a second configuration with respect to a second type of post, wherein the first insulator and the second insulator are substantially the same.

19. The method of claim 18 further comprising attaching a wire to the first insulator and the second insulator.

20. The method of claim 18 further comprising orienting a third insulator in a third configuration with respect to a third type of post, wherein the first insulator and the second insulator are substantially the same.
